(19) United States
(12) Patent Application Publication
(10) Pub. No.: US 2026/0249981 A1
(43) Pub. Date: Aug. 27, 2026

(54) HIGH LIFT SYSTEM MONITORING AND CONTROL ARRANGEMENT FOR AIRCRAFT

(71) Applicant: Airbus Operations GmbH, Hamburg (DE)

(72) Inventor: Jan HASERODT, Osterholz-Scharmbeck (DE)

(21) Appl. No.: 19/550,882

(22) Filed: Feb. 26, 2026

(30) Foreign Application Priority Data
Feb. 27, 2025 (DE) 102025000718-3

(51) Int. Cl. B64C 13/16; B64D 45/00

(52) U.S. Cl. CPC B64C 13/16; B64D 45/0005

(57) ABSTRACT

A high lift system monitoring arrangement (24) includes: a sensor (32), a monitoring unit (34) connected to the sensor (32), wherein the monitoring unit (34) includes: an acquisition module (46), that acquires an analog sensed information (AI) from the sensor (32), a processing module (48) having a first processing circuitry (48A) and a second processing circuitry (48B), different from the first circuitry, wherein the first processing circuitry (48A) processes the analog sensed information (AI) into a first digital sensor data (DD1), the second processing circuitry (48B) processes the analog sensed information (AI) into a second digital sensor data (DD2).

### RELATED APPLICATION

This application claims priority to and incorporates by reference to German patent application DE 102025000718-3, filed February 27, 2025.

### BACKGROUND

The present disclosure relates to a high lift system monitoring arrangement. The present disclosure also relates to a high lift system comprising such a high lift system monitoring arrangement. The disclosure further relates to an aircraft comprising such a high lift system arrangement. The disclosure further relates to a method of monitoring a high lift system using a high lift system monitoring arrangement as above mentioned.

In the domain of high lift systems for aircrafts, one knows using monitoring device, for example for ensuring that loads and/or displacements values in the high lift system remain nominal.

To that end, one knows for example using high lift system monitoring devices comprising sensors such as proximity switches, linear variable differential transformers (generally abbreviated LVDT), rotary variable differential transformers (generally abbreviated RVDT) synchros or resolvers. The previously mentioned sensors are known for their reliability but typically provide an analog connection to the rest of the high lift system and have accuracy limits.

In other technological fields, one also knows more compact and accurate sensors, but such sensors typically have a digital interface and comprise a processing circuitry which poses challenges due to certification requirements of the aviation industry for complex electronic hardware.

The above-mentioned prior art is therefore not entirely satisfying in that it has accuracy limitations and requires specific analog interfaces for its integration in the aircraft.

### SUMMARY

The invention disclosed herein may be embodied to provide a high lift monitoring system which allows the integration of more precise sensors simultaneously improving the interfacing of sensors and allowing for more precise measurement.

To this end, the invention relates to a high lift system monitoring arrangement comprising: at least one sensor, and a monitoring unit, connected to the at least one sensor, the monitoring unit comprising: an acquisition module, configured for acquiring an analog sensed information from the at least one sensor, and a processing module, comprising a first processing circuitry and a second processing circuitry, different from the first circuitry, wherein the first processing circuitry is configured to process the analog sensed information into a first digital sensor data, the second processing circuitry being configured to process the analog sensed information into a second digital sensor data.

The use of a processing module comprising different first processing circuitry and second processing circuitry to process in parallel the analog sensed information into a first digital sensor data and a second digital sensor data is especially advantageous since this ensures limiting the impact of a potential error/failure in one of the processing circuitry, enabling a compliance of the sensing arrangement also for safety critical functions.

According to other advantageous aspects of the invention, the high lift system monitoring arrangement comprises one or more of the following features taken alone or according to all technically possible combinations:

the first digital sensor data corresponds to the second digital sensor data;

the monitoring unit further comprises a communication module, the communication module being configured to communicate an output data based on the first and/or second digital sensor data;

the monitoring unit further comprises a controlling module, the controlling module being configured to control an actuation of the high lift system based on the first and/or second digital sensor data;

the at least one sensor is a displacement sensor;

the at least one sensor comprises a target, configured to be installed on a moveable portion of the high lift system, and an antenna, configured to be installed on a fixed portion of the high lift system;

at least one of the target and of the antenna comprises a printed circuit board; and

the high lift system monitoring arrangement comprises a plurality of sensors, the monitoring unit being connected to each sensor, the acquisition module being configured for acquiring an analog sensed information from each of the sensors, the first processing circuitry being configured to process the analog sensed information of each sensor into a respective first digital sensor data, the second processing circuitry being configured to process the analog sensed information of each sensor into a respective second digital sensor data.

The invention also relates to high lift system comprising a high lift system monitoring arrangement as presented above.

The invention may be embodied to relate to an aircraft comprising a high lift system as presented above.

The invention may further be embodied to relate to a method of monitoring a high lift system using a high lift system monitoring arrangement as presented above, wherein the method comprises the steps of:

acquiring an analog sensed information from the at least one sensor of the high lift system monitoring arrangement; and

processing the analog sensed information by the processing module of the monitoring unit of the high lift system monitoring arrangement, wherein the first processing circuitry of the processing module is configured to process the analog sensed information into a first digital sensor data, the second processing circuitry being configured to process the analog sensed information into a second digital sensor data.

### SUMMARY OF DRAWINGS

The invention will be better understood when reading the following description, which is given solely by way of example and with reference to the appended drawings, in which:

FIG. 1 is a schematic view of an aircraft comprising a high lift system with a high lift system monitoring arrangement according to the invention; and

FIG. 2 is a schematic representation of a high lift system monitoring arrangement according to the invention.

### DETAILED DESCRIPTION

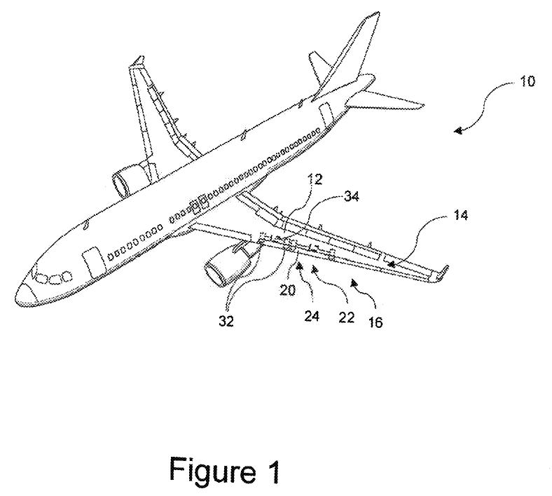

Referring to FIG. 1, an aircraft 10 comprises a fuselage 12 and wings 14. The aircraft 10 is for example an airplane and is for example an airliner. The aircraft 10 includes a high lift system 16, for example arranged on the wings 14.

The high lift system 16 may include a wing body 18, a moveable surface 20 and a high lift system architecture 22. In the example illustrated on FIG. 1, the high lift system 16 comprises a plurality of moveable surfaces 20.

As visible from FIG. 1, the wing body 18 is for example a portion of the wing 14 which is fixed relative to the fuselage 12. In a non- illustrated example, the main body 14 corresponds to a main body of a foldable wing tip.

For example, and as visible from FIG. 1, the moveable surface 20 is a slat. In other words, in such an example, the high lift system 16 forms a leading-edge high lift system/device.

In other non-illustrated examples, the moveable surface 20 is a flap. In such non illustrated examples, the high lift system 16 may form a trailing-edge high lift system/device.

The moveable surface 20 is moveable relative to the wing body 18. For example, the moveable surface 20 is moveable between a stowed position and a deployed position, the moveable surface 20 being further away from the wing body 18 when it is in its deployed position than when it is in its stowed position.

The high lift system architecture 22 comprises a high lift system monitoring arrangement 24. In an example, the high lift system architecture 22 comprises at least one actuator 26.

The at least one actuator 26 comprises a fixed portion 28 and at least one moveable portion 30, the moveable portion 30 of the actuator being moveable relative to the fixed portion 28.

The at least one actuator 26 is for example configured for moving the moveable surface 20 relative to the wing body 18 between its stowed and deployed positions.

For example, the fixed portion 28 of the actuator 26 is fastened to the wing body 18 and the moveable portion 30 of the actuator 26 is connected to the moveable surface 20, for example such that a movement of the moveable portion 30 of the actuator 26 relative to the fixed portion 28 of the actuator 26 displaces the moveable surface 20 relative to the wing body 18.

For example, the actuator 26 comprises a Geared Rotary Actuator (generally abbreviated GRA), the fixed portion 28 corresponding for example to a housing of such GRA and the moveable portion 30 comprising for example to a rotary shaft of such GRA. The housing of such a GRA is for example fastened to the wing body 18 and the rotary shaft of such a GRA is for example configured to engage with a track (non- referenced) of the moveable surface 20.

In another example, the actuator comprises a linear actuator, the fixed portion 28 corresponding for example to a housing of such a linear actuator and the moveable portion 30 comprising for example a rotary shaft of such a linear actuator. The housing of such a linear actuator is for example fastened to the wing body 18 and the rotary shaft of such a linear actuator is for example configured to engage with a travelling nut (non- referenced) of the moveable surface 20.

The high lift system monitoring arrangement 24 comprises at least one sensor 32 and a monitoring unit 34. As schematically illustrated on the port wing 14 of FIG. 1, and for example, the high lift system monitoring arrangement 24 comprises a plurality of sensors 32. For example, and as illustrated in FIG. 1, the high lift system monitoring arrangement 24 further comprises a plurality of monitoring units 34.

The at least one sensor 32 is for example a displacement sensor. In other examples, the at least one sensor 32 is for example a load sensor.

The at least one sensor 32 comprises for example a target 36 and an antenna 38.

The target 36 is for example configured for being installed on a moveable portion 40 of the high lift system. For example, the moveable portion 40 of the high lift system corresponds to the moveable portion 30 of the actuator as above mentioned. In particular, in such an example, the target 36 is for example arranged on the rotary shaft of a GRA or linear actuator as above mentioned.

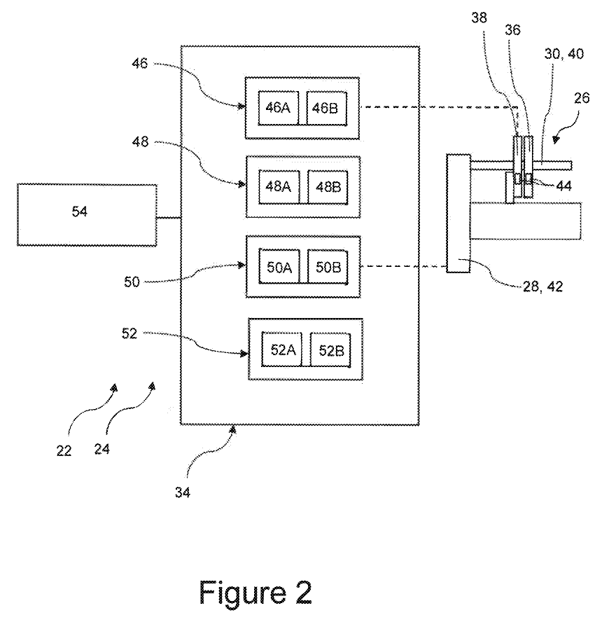

As understood from FIG. 2, in such an example, and for example, the target 38 of the sensor 32 forms a disk radially arranged around the rotary shaft, the target 38 being thus extending along an orthoradial and circular sensing direction.

In other examples, the target 36 is configured for being arranged on any other moveable portion 40 of the high lift system 16. In such other examples, the target 36 might be a linear target and might be elongated, for example along a linear sensing direction.

The antenna 38 is for example configured for being installed on a fixed portion 42 of the high lift system. For example, the fixed portion 42 of the high lift system corresponds to the fixed portion 28 of the actuator as above mentioned. In particular, in such an example, the antenna 38 is for example fastened/fixed to the housing of a GRA or linear actuator as above mentioned.

As understood from FIG. 2, in such an example, and for example, the antenna 38 of the sensor 32 forms a disk radially arranged around the rotary shaft, the antenna being thus extending along an orthoradial and circular sensing direction.

In other examples, the antenna 38 is configured for being arranged on any other fixed portion 42 of the high lift system 16. In such other examples, the antenna 38 might be a linear antenna and might be elongated, for example along a linear sensing direction.

As visible from FIG. 2, the target 36 and the antenna 38 are facing each other, for example for generating an analog sensed information Al (which will be presented in more details later).

For example, a sensor 32 comprising a target 36 and an antenna 38 as above mentioned is forming an inductive encoder. In such an inductive encoder, relative displacement of the target 36 relative to the antenna 38 induces a change in a magnetic field sensed by the antenna 36, which transcribes/corresponds to the relative displacement of the target 36 relative to the antenna 38.

In such an example, the analog sensed information Al corresponds for example to magnetic field value sensed by the sensor 32, and for example by the antenna 36. In alternative, the analog sensed information Al corresponds to an analog information derived from such magnetic field value, such as for example an analog displacement value corresponding to the magnetic field value.

In other example, and for example when the sensor 32 differs from a sensor comprising a target 36 and an antenna 38 as above mentioned, the analog sensed information Al corresponds to an analog signal generated by the sensor 32, such as for example an analog electric signal.

The analog sensed information Al thus corresponds to an analog signal sensed by the sensor 32, such signal being for example representative of a displacement and/or a load in the high lift system 16.

For example, the sensor 32 comprises at least one printed circuit board 44 (abbreviated PCB). The printed circuit board 44 is for example configured for generating the analog sensed information AI.

For example, when the sensor 32 comprises a target 36 and an antenna 38 as above mentioned, at least one of the target 36 and the antenna 38 comprises a printed circuit board 44.

For example, the or each printed circuit board 44 is configured to emit and/or sense a magnetic field, such that the sensor 32 generates the analog sensed information AI. In an example, the sensor 32 does not comprise any coil and relies on the printed circuit board 44 for emitting and/or sensing the magnetic field.

The monitoring unit 34 is connected to the at least one sensor 32. When the monitoring unit 34 comprises a plurality of sensors 32, and for example, the monitoring unit 34 is connected to each sensors 32.

In a further example, and as schematically illustrated on the port wing 14 of FIG. 1, the high lift system monitoring arrangement 24 comprises a plurality of monitoring units 34 (two monitoring units 34 being represented on FIG. 1), each monitoring unit 34 being connected to a plurality of sensors 32 (each monitoring unit 34 being presented connected with two sensors 32 on FIG. 1).

The monitoring unit 34 comprises an acquisition module 46 and a processing module 48. Furthermore, for example, and as illustrated in FIG. 2, the monitoring unit 34 further comprises a controlling module 50 and/or a communication module 52.

As this will be presented in more details later, the monitoring unit 34 is for example implemented in a Motor Control Electronic (abbreviated MCE) of the high lift system 16.

As illustrated from FIG. 2, the acquisition module 46 is configured for acquiring the analog sensed information Al from the at least one sensor 32 to which the acquisition module 46 is connected.

For example, when the monitoring unit 34 is connected to a plurality of sensors 32, the acquisition module 46 is configured for acquiring analog sensed information Al from each of the sensors 32.

The acquisition module 46 is for example connected with the or each sensor 32 with a discrete connection cable, illustrated in FIG. 2 but non-referenced.

In the example presented on FIG. 2, the acquisition module 46 comprises a first acquisition circuitry 46A and a second acquisition circuitry 46B, different from the first acquisition circuity. Both the first 46A and second 46B acquisition circuitries are for example configured for acquiring the analog sensed information Al from the or each sensor(s) 32

The processing module 48 is configured to process the analog sensed information Al.

The processing module 48 comprises in particular a first processing circuitry 48A and a second processing circuitry 48B, different from the first processing circuitry 48A.

In the example of FIG. 2, the first processing circuitry 48A is connected to the first acquisition circuitry 46A to receive the analog sensed information Al from the first acquisition circuitry 46A and the second processing circuitry 48B is connected to the second acquisition circuitry 46B to receive the analog sensed information Al from the second acquisition circuitry 46B.

In another non-represented example, the first acquisition circuitry 46A is connected to both the first 48A and second 48B processing circuitries and the second acquisition circuitry 46B is connected to both the first 48A and second 48B processing circuitries. In such an example, the first processing circuitry 48A is then for example configured to receive/preprocess the analog sensed information Al from the first 46A and second 46B acquisition circuitries and the second processing circuitry 48B is configured to receive/preprocess the analog sensed information Al from the first 46A and second 46B acquisition circuitry.

The processing module 48 is for example implemented in an MCE as above mentioned. For example, the MCE comprises two dissimilar and segregated electronic boards, using different electronic components, and designated as CON board and MON board. In such an example, the CON board comprises for example the first processing circuitry 48A and the MON board comprises the second processing circuitry 48B.

The first processing circuitry 48A is configured for processing the analog sensed information Al into a first digital sensor data DD1. For example, the first processing circuitry 48A is configured for processing the analog sensed information Al acquired by the first acquisition circuitry 46A into to first digital sensor data DD1.

In the example in which the acquisition module 46 is configured for acquiring an analog sensed information Al from a plurality of sensors 32, the first processing circuitry 46A is for example configured to process the analog sensed information Al of each sensor 32 into a respective first digital sensor data DD1.

In an example the first processing circuitry 48A only applies a digitalization on the analog sensed information AI. In another example, the first processing circuitry 48A further processes the analog sensed information AI, for example to convert an acquired current value (analog sensed information AI) to a digital value corresponding to a position and/or a load in the high lift system 16 (first digital sensor data DD1).

The second processing circuitry 48B is configured for processing the analog sensed information Al into a second digital sensor data DD2. For example, the second processing circuitry 48B is configured for processing the analog sensed information Al acquired by the second acquisition circuitry 46B into to first digital sensor data DD1.

In the example in which the acquisition module 46 is configured for acquiring an analog sensed information Al from a plurality of sensors 32, the second processing circuitry 46B is for example configured to process the analog sensed information Al of each sensor 32 into a respective second digital sensor data DD2.

In an example the second processing circuitry 48B only applies a digitalization on the analog sensed information AI. In another example, the second processing circuitry 48B further processes the analog sensed information AI, for example to convert an acquired a current value (analog sensed information AI) to a digital value corresponding to a position and/or a load in the high lift system 16 (second digital sensor data DD2).

The first digital sensor data DD1 corresponds for example to the second digital sensor data DD2. In particular, the first digital sensor data DD1 and the second digital sensor data DD2 result from similar transformation of the analog sensed information AI, realized by different electronic components, that is by the first processing circuitry 48A and by the second processing circuitry 48B. In other words, the first digital sensor data DD1 and the second digital sensor data DD2 are only differing in that they are processed by different electronic components, these data being similar data for a normal functioning of the monitoring unit 34.

The controlling module 50 is for example configured to control an automatic actuation of the high lift system 16 based on the first DD1 and/or second digital sensor data DD2.

As illustrated in FIG. 2, the controlling module 50 is for example connected to the at least one actuator 26. The controlling module 50 is for example configured for implementing a logic which, based on the first DD1 and/or second digital sensor data DD2, controls the at least one actuator 26.

The controlling module 50 is for example configured to compare the first DD1 and the second DD2 digital sensor data and to use one of the first DD1 or second DD2 data for controlling the at least one actuator 26, if the result, e.g., variance between the first DD1 and second DD2 digital sensor data, of the comparison is below a predetermined threshold. The controlling module 50 is for example configured to generate an alert signal, for example to be displayed on human machine interface (non-represented) and/or to be transmitted to a flight control computer 54 of the aircraft, if the result of the comparison is greater or equal to the predetermined threshold. Also, the controlling module 50 may disable the automatic actuation of the actuator for the high lift device if the result of the comparison is a variance equal or greater than the predetermined threshold.

In another non-illustrated example, and as understood below, the controlling is implemented in the flight control computer 54 of the aircraft. In such an example, the communication module 52 is for example configured to communicate an output data 0 corresponding to the first DD1 and second DD2 digital sensor data, such that the flight control computer implements a comparison of the first DD1 and the second DD2 digital sensor data as above described The flight control computer 54 is then for example configured to generate an alert signal, for example to be displayed on human machine interface (non-represented), if the result of the comparison is superior or equal to the predetermined threshold.

In an example, the controlling module 50 is configured to fuse the first DD1 and the second DD2 digital sensor data and to control the at least one actuator 26 based on such a fused data.

In addition, or in alternative, the controlling module 50 is connected to the acquisition module 46, and is configured to control the automatic actuation of the high lift system 16, and for example of the at least one actuator 26, based on the acquired analog sensed information AI.

In addition, or in alternative, the controlling module 50 is connected to the flight control computer 54 of the aircraft, for example through the communication module 52 as presented below.

The controlling module 50 is for example configured for receiving an actuation instruction from the flight control computer 54, such an actuation instruction being for example determined by the flight control computer based on the first DD1 and/or second DD2 digital sensor data.

In the example presented in FIG. 2, the controlling module 50 comprises a first controlling circuitry 50A and a second controlling circuitry 50B. In such an example, each controlling of the first 50A and second 50B controlling circuitry is for example configured for generating and/or receiving an actuation instruction, based on the first DD1 and/or second DD2 digital sensor data. The actuator 26 is for example configured for automatic actuating the actuator 26 based on the actuation instruction generated and/or received by the first 50A and/or the second 50B controlling circuitry. In other non-illustrated examples, the controlling module 50 comprises a single circuitry, connected to the first processing circuitry 48A and to the second processing circuitry 48B and for example configured for controlling the actuation based on the first DD1 and/or second digital sensor data DD2.

The communication module 52 is for example configured to communicate an output data 0 based on the first DD1 and/or second DD2 digital sensor data.

For example, the communication module 52 is connected to the processing module 48 and configured for obtaining the first DD1 and/or second DD2 digital sensor data from the processing module 48.

The communication module 54 is configured to generate an output data 0 based on the first DD1 and/or second DD2 digital sensor data. In an example, the output data O results of the first DD1 and second DD2 digital sensor data.

The communication module 52 is for example connected to the flight control computer 54 of the aircraft, the communication module 52 being configured for transmitting the output data O to the flight control computer 54.

In an example, the communication module 52 is configured to communicate the output data O and/or an actuation instruction of the flight control computer 54, to the controlling module 50.

In the example presented in FIG. 2, the communication module 52 comprises a first communication circuitry 52A and a second communication circuitry 52B. In an example, the output data O comprise the first DD1 and second DD2 digital sensor data.

In such examples, and as above mentioned, the communication module 52 is for example configured to fuse the first DD1 and second DD2 digital sensor data into the output data O.

One understands that during data fusion, incoherent first DD1 or second DD2 digital are for example excluded for the generation of the output data O.

For example, and as presented in FIG. 2, the acquisition module 46, the processing module 48, the controlling module 50 and the communication module 52 are each implemented as analog signal processing/data storing devices.

In particular, in the example of FIG. 2, the first acquisition circuitry 46A, the first processing circuitry 48A, the first controlling circuitry 50A and the first communication circuitry 52A are implemented on an electronic board, and in particular on a CON board of a MCE. In the example of FIG. 2, the second acquisition circuitry 46B, the second processing circuitry 48B, the second controlling circuitry 50B and the second communication circuitry 52B are implemented on an electronic board, and in particular on a MON board of a MCE.

In a variant (not shown), the acquisition module 46, the processing module 48, the controlling module 50 and the communication module 52 are each produced in the form of a programmable logic components, such as a FPGA (Field Programmable Gate Array), or in the form of a dedicated integrated circuit, such as an ASIC (Application Specific Integrated Circuit), or in the form of any combination of ASIC, FPGA and/or software. In such a variant, the processing module 48, and for example the acquisition module 46, the controlling module 50 and the communication module 52 each comprise two dissimilar and segregated programmable logic components, dedicated integrated circuit or combination of ASIC, FPGA and/or software.

A method of monitoring a high lift system using a high lift system monitoring arrangement as above described will now be presented.

In an acquiring step, an analog sensed information Al is acquired from the at least one sensor 26 of the high lift system monitoring arrangement 24. In particular, the acquisition module 46 is acquiring the analog sensed information Al for the at least one sensor 26.

In a processing step, the analog sensed information Al is processed by the processing module 48. In particular, during the processing step, the first processing circuitry 48A processes the analog sensed information into a first digital sensor data DD1 and the second processing circuitry 48B processes the analog sensed information into a second digital sensor data DD2.

A high lift system monitoring arrangement 24 as above presented, and in particular in which two distinct processing circuitry 48A, 48B are configured to process the analog sensed information Al into first DD1 and second DD2 digital sensor data, is especially relevant to relevant to perform safety critical functions of the high lift system monitoring arrangement.

Having a communication module 52 being configured to communicate an output data 0 based on the first DD1and/or second DD2 digital sensor data is especially relevant to improve integration of the monitoring arrangement 24 without compromising its safety. Having a monitoring unit 34 comprising a controlling module 50 configured to control an actuation of the high lift system 16 based on the first DD1 and/or second digital sensor data DD2 is especially advantageous, in particular since it allows for example decentralizing the controlling of the high lift system 16, further improving the controlling of the high lift system 16.

The use of a sensor 32 as above described, for example a displacement sensor, and in particular a sensor 32 having a target 36 and an antenna 38, for example equipped with a printed circuit board 44, is especially advantageous for accuracy on the analog sensed information AI, and ultimately on the first DD1 and second DD2 digital sensor data.

A high lift system monitoring arrangement 24 as above presented in which the monitoring arrangement 24 comprises a plurality of sensors 32 and in which the monitoring unit 34 is connected to each sensor 32 and processes the sensed information Al of each sensor into a first DD1 and a second DD2 digital sensor data is especially advantageous for making the monitoring arrangement 24 efficient, without compromising its accuracy.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms "comprise" or "comprising" do not exclude other elements or steps, the terms "a" or "one" do not exclude a plural number, and the term "or" means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGNS

10 aircraft

12 fuselage

14 wing

16 high lift system

18 wing body

20 moveable surface

22 high lift system architecture

24 high lift system monitoring arrangement

26 actuator

28 fixed portion of the actuator

30 moveable portion of the actuator

32 sensor

34 monitoring unit

36 target

38 antenna

40 moveable portion of the high lift system

42 fixed portion of the high lift system

44 printed circuit board

46 acquisition module

46a first acquisition circuitry

46b second acquisition circuitry

48 processing module

48a first processing circuitry

48b second processing circuitry

50 controlling module

50a first controlling circuitry

50b second controlling circuitry

52 communication module

52a first communication circuitry

52b second communication circuitry

54 flight control computer

AI analog sensed information

DD1 first digital sensor data

DD2 second digital sensor data

O output data

1. A high lift system monitoring arrangement comprising:
at least one sensor, and
a monitoring unit connected to the at least one sensor, wherein the monitoring unit includes:
an acquisition module configured to acquire analog sensed information from the at least one sensor,
a processing module including:
a first processing circuitry, and
a second processing circuitry different from the first processing circuitry,
wherein the first processing circuitry is configured to process the analog sensed information into first digital sensor data and the second processing circuitry is configured to process the analog sensed information into a second digital sensor data, and
a controlling module configured to control actuation of the high lift system based on the first digital sensor data and/or the second digital sensor data.

2. The high lift system monitoring arrangement according to claim 1, wherein the first digital sensor data corresponds to the second digital sensor data.

3. The high lift system monitoring arrangement according to claim 1, wherein the monitoring unit further comprises a communication module configured to communicate output data based on the first digital sensor data and/or the second digital sensor data.

4. The high lift system monitoring arrangement according to claim 1, wherein the controlling module configured disable the actuation of the high lift system if a variance between the first digital sensor data and the second digital sensor data is equal to or exceeds a threshold.

5. The high lift system monitoring arrangement according to claim 1, wherein the at least one sensor is a displacement sensor.

6. The high lift system monitoring arrangement according to claim 5, wherein the at least one sensor includes:
a target configured to be installed on a moveable portion of the high lift system, and
an antenna configured to be installed on a fixed portion of the high lift system.

7. The high lift system monitoring arrangement according to claim 6, wherein at least one of the target and of the antenna includes a printed circuit board.

8. The high lift system monitoring arrangement according to claim 1, wherein the high lift system monitoring arrangement,
wherein the at least one sensor is a plurality of sensors,
wherein the monitoring unit is connected to each of the plurality of sensor,
wherein the acquisition module is configured to acquire an analog sensed information from each of the plurality of sensors,
wherein the first processing circuitry is configured to process the analog sensed information of each of the plurality of sensors into a respective one of the first digital sensor data, and
wherein the second processing circuitry is configured to process the analog sensed information of each of the plurality of sensors into a respective second digital sensor data.

9. A high lift system comprising the high lift system monitoring arrangement according to claim 1.

10. An aircraft comprising the high lift system according to claim 9.

11. A method of monitoring a high lift system on an aircraft wing using a high lift system monitoring arrangement, wherein the method includes:
acquiring analog sensed information from at least one sensor of the high lift system monitoring arrangement;
processing the analog sensed information by a processing module of a monitoring unit of the high lift system monitoring arrangement, wherein a first processing circuitry of the processing module processes the analog sensed information into first digital sensor data and a second processing circuitry process the analog sensed information into second digital sensor data, and
automatically controlling an actuator of the high lift system to move the high lift system relative to a fixed wing portion of the aircraft wing using the first digital sensor data or the second digital sensor data.

12. A method to control a high lift device on a wing of an aircraft, the method incudes:
obtaining analog senor data indicative of a position of or load on the high lift device data, wherein the analog sensor data is acquired by a sensor monitoring the high lift device;
converting the analog sensor data into first digital sensor data with a first processing circuit,
converting the analog sensor data into second digital sensor data with a second processing circuit electronically separate from the first processing circuit;
comparing the first digital sensor data to the second digital sensor data to determine if a variance between the first and second digital sensor data is within a threshold;
automatically controlling an actuator of the high lift system to move the high lift system relative to a fixed wing portion of the wing using the first digital sensor data or the second digital sensor data and if the variance is within the threshold;
issuing an alert signal if the variance is beyond the threshold, and
disabling automatic actuation of the actuator to move the high lift system if the variance is beyond the threshold.

13. The method of claim 12, where the step of using the first digital data sensor data or the second digital sensor data to automatically control the actuator includes fusing the first digital sensor data and the second digital sensor data to generate fused digital sensor data and using the fused digital sensor data to control the actuator.

14. The method of claim 12, wherein the issuing of the alert signal includes transmitting the alert signal to a flight control computer of the aircraft.

15. The method of claim 12, wherein the automatically controlling the actuator when the variance is within the threshold includes receiving an actuation instruction from a flight control computer and using the actuation instruction to actuate the actuator to move the high lift device.
